(19) United States
(12) Patent Application Publication
(10) Pub. No.: US 2009/0110053 A1
(43) Pub. Date: Apr. 30, 2009

(54) EMBEDDED SYSTEM AND REMOTE-CONTROL SERVO APPARATUS THEREOF

(75) Inventor: Jun Liu, Taipei City (TW)

Correspondence Address: J C PATENTS, INC., 4 VENTURE, SUITE 250, IRVINE, CA, 92618, US

(73) Assignee: INVENTEC CORPORATION, Taipei City (TW)

(21) Appl. No.: 12/027,171

(22) Filed: Feb. 6, 2008

(30) Foreign Application Priority Data
Oct. 25, 2007 (TW) 96140055

(51) Int. Cl. H04B 1/66

(52) U.S. Cl. 375/240.01

(57) ABSTRACT

A remote-control servo apparatus of an embedded system is provided. The remote-control servo apparatus includes a compression unit and a network interface unit. The compression unit coupled to an image output interface of the embedded system receives and compresses an output image of the embedded system to generate a compressed image. The network interface unit coupled between the compression unit and a remote apparatus transmits the compressed image output from the compression unit to the remote apparatus via a network. An input-event of the remote apparatus is transmitted to an input apparatus interface of the embedded system via the network and the network interface unit. Therefore, the remote apparatus can operate the embedded system through the remote-control servo apparatus.

### CROSS-REFERENCE TO RELATED APPLICATION

This application claims the priority benefit of Taiwan application serial no. 96140055, filed on Oct. 25, 2007. The entirety of the above-mentioned patent application is hereby incorporated by reference herein and made a part of this specification.

### BACKGROUND OF THE INVENTION

1. Field of the Invention

The present invention relates to an embedded system and a remote-control servo apparatus thereof. More particularly, the present invention relates to an embedded system capable of being remote-controlled and a remote-control servo apparatus thereof.

2. Description of Related Art

Embedded system has become one of the key techniques in the modern electronic/information industry. Take home server which is newly developed by Microsoft for example. FIG. 1A is a block diagram of a conventional embedded system. The embedded system 100 includes a central processing unit (CPU) 101, a chip set (including a north-bridge chip 102 and a south-bridge chip 103), a network card 104, a display card 105, and an input controller 106. The embedded system provides various services, such as file service, via the network card 104. Therefore, a remote personal computer (PC) 120 obtains the service resources provided by the embedded system 100 via a network 110 and the network card 104. In order to inspect/manage the embedded system 100, a user can use a local display 130 and input apparatus (a keyboard 140 and a mouse 150). The display card 105 generates an output image to the display 130 under the control of the north-bridge chip 102. The input controller 106 is coupled to the south-bridge chip 103, for receiving an input apparatus signal sent by the input apparatus, and outputting a corresponding input interrupt to the south-bridge chip 103. Thereby, the CPU 101 can operate correspondingly according to the input interrupt. However, this control manner has to be performed at the local side of the embedded system 100.

FIG. 1B is a block diagram of another conventional embedded system. Without I/O apparatus such as keyboard, mouse, and display, the embedded system 100 communicates with the external via a network. In order to inspect/manage the embedded system 100, a user can use remote apparatus (the display 130, the keyboard 140, the mouse 150, and a PC 160). This conventional control manner is performed via a web-page interface. After the embedded system 100 is powered on, its operating system executes system programs/application programs to provide a web-page browsing service for inspecting/managing the embedded system 100. Therefore, the remote apparatus (the display 130, the keyboard 140, the mouse 150, and the PC 160) can use the inspection/management service provided by the embedded system 100 via the network 110. However, when the embedded system 100 fails to work normally and cannot provide the inspection/management service, the remote apparatus cannot control the embedded system 100.

### SUMMARY OF THE INVENTION

The present invention is directed to provide a remote-control servo apparatus, for transmitting a display frame of an embedded system to a remote apparatus via a network, and transmitting an input-event of the remote apparatus to an input apparatus interface of the embedded system via the network. Therefore, even if the embedded system has not finished the preparation for providing services, and is still in a Power On Self Test (POST) stage, the remote-control servo apparatus can help the remote apparatus to control/operate/monitor the embedded system at remote side.

The present invention is further directed to provide an embedded system. Even if the embedded system has not finished the preparation for providing services, and is still in a POST stage, the embedded system can accept a remote apparatus controls, operates, and monitors the embedded system itself at remote side.

To solve the above problem, the present invention provides a remote-control servo apparatus including a compression unit and a network interface unit. The compression unit is coupled to an image output interface of an embedded system, for receiving and compressing an output image of the embedded system to generate a compressed image. The network interface unit is coupled between the compression unit and a remote apparatus, for transmitting the compressed image output from the compression unit to the remote apparatus via a network. An input-event of the remote apparatus is transmitted to an input apparatus interface of the embedded system via the network and the network interface unit. Therefore, the remote apparatus operates the embedded system through the remote-control servo apparatus.

The present invention further provides an embedded system including a chip set, a first network interface unit, a display chip, an input apparatus interface, and a remote-control servo apparatus. The first network interface unit is coupled to the chip set, in which the embedded system provides services via the first network interface unit. The display chip is coupled to the chip set, for generating an output image under the control of the chip set. The input apparatus interface is coupled to the chip set, for receiving an input apparatus signal and outputting a corresponding input interrupt to the chip set. The remote-control servo apparatus includes a compression unit and a second network interface unit. The compression unit is coupled to the display chip, for receiving and compressing the output image to generate a compressed image. The second network interface unit is coupled between the compression unit and a remote apparatus, for transmitting the compressed image output from the compression unit to the remote apparatus via a network. An input-event of the remote apparatus is transmitted to the input apparatus interface via the network and the second network interface unit. Therefore, the remote apparatus operates the embedded system through the remote-control servo apparatus.

According to the present invention, a remote-control servo apparatus is employed to transmit a display frame of an embedded system to a remote apparatus via a network, and transmit an input-event of the remote apparatus to an input apparatus interface of the embedded system via the network. Therefore, even if the embedded system has not finished the preparation for providing services, and is still in a POST stage, the remote-control servo apparatus can help the remote apparatus to control/operate/monitor the embedded system at the remote side.

In order to make the aforementioned and other objectives, features, and advantages of the present invention comprehensible, embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a block diagram of a conventional embedded system.

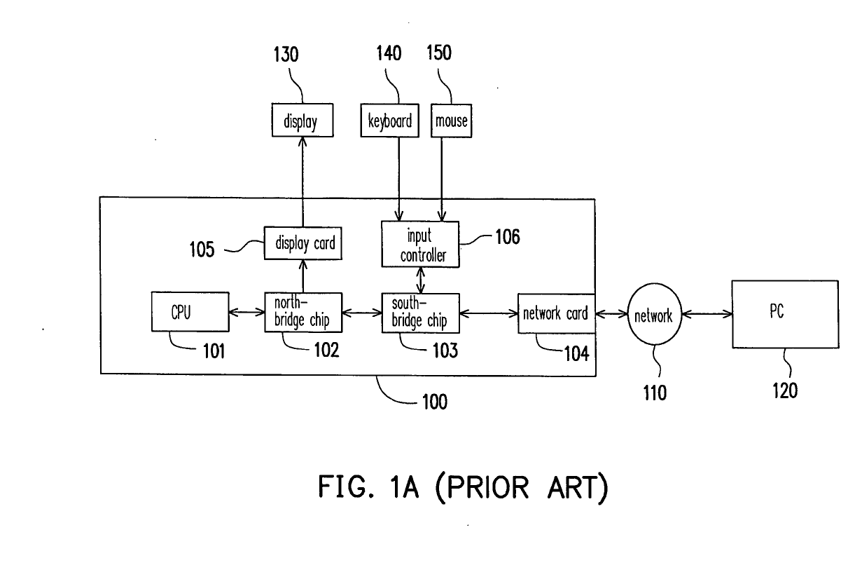

FIG. 1B is a block diagram of another conventional embedded system.

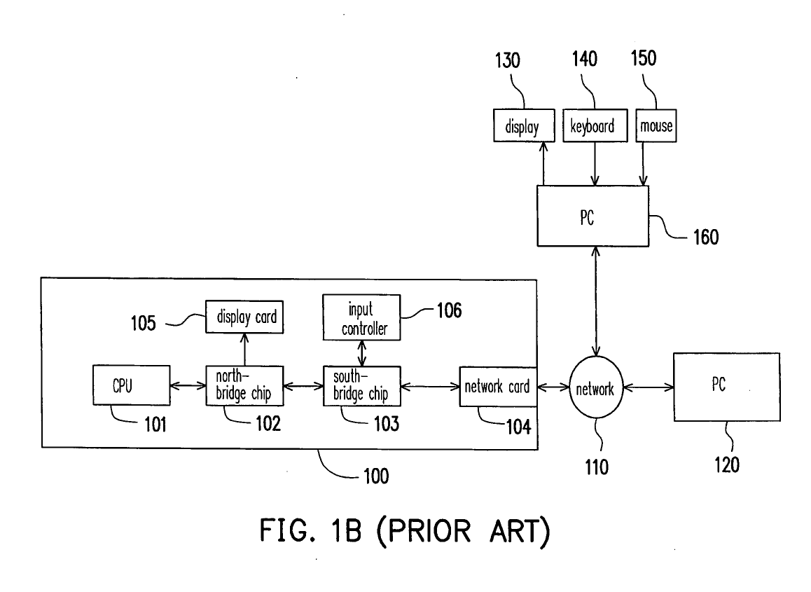

FIG. 2 is a block diagram of an embedded system and a remote-control servo apparatus according to an embodiment of the present invention.

FIG. 3 is an embedded system according to another embodiment of the present invention.

### DESCRIPTION OF EMBODIMENTS

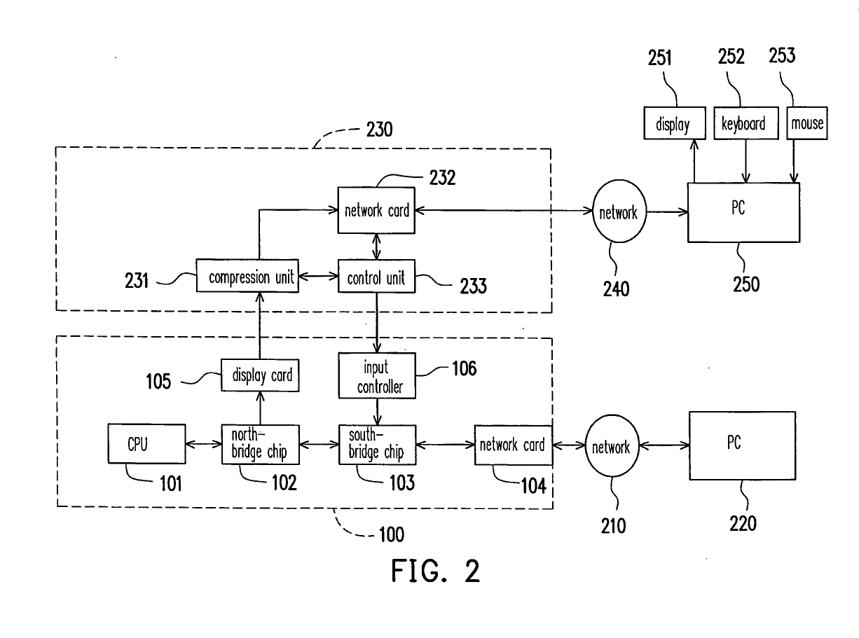

The implementation and application of the embedded system is not limited to the following embodiments. For example, home server developed by Microsoft is an example of embedded systems. FIG. 2 is a block diagram of an embedded system and a remote-control servo apparatus according to an embodiment of the present invention. The embedded system 100 includes a central processing unit (CPU) 101, a chip set (including a north-bridge chip 102 and a south-bridge chip 103), a first network interface unit (a network card 104 herein), an image output interface (a display card 105 herein), and an input apparatus interface. In this embodiment, the input apparatus interface may include an input controller 106 and various types of connectors (not shown). The input apparatus interface is capable of making input apparatus (such as a mouse and a keyboard) connected to the embedded system 100.

The embedded system 100 provides various services, such as file service, for a network apparatus, e.g., a personal computer (PC) 220, via the network card 104 and a network 210, e.g., a local area network (LAN). Therefore, the remote PC 220 obtains the service resources provided by the embedded system 100 via the network 210 and the network card 104.

In the embedded system 100, the display card 105 generates an output image under the control of the north-bridge chip 102. In this embodiment, the display card 105 is a video graphics array (VGA) display card or other types of display card or display chip. Further, the input controller 106 coupled to the south-bridge chip 103 receives an input apparatus signal sent by external input apparatus (such as a keyboard, not shown), and outputs a corresponding “input interrupt” to the south-bridge chip 103. Therefore, the CPU 101 can operate correspondingly according to the input interrupt.

In this embodiment, a remote-control servo apparatus 230 is connected to the display card 105 and the input controller 106, so as to transmit a display frame of the embedded system 100 to a display 251 of a remote apparatus (for example, a PC 250) via a network 240, and to transmit an input-event (for example, a user operating a keyboard 252 and/or a mouse 253) of the PC 250 to the input controller 106 of the embedded system 100 via the network 240. Thus, even if the embedded system 100 has not finished the preparation for providing services, and is still in a POST stage, the remote-control servo apparatus 230 can help the remote apparatus (i.e., the PC 250) to control/operate/monitor the embedded system 100 at the remote side.

The implementation of the remote-control servo apparatus 230 is illustrated below according to this embodiment. The remote-control servo apparatus 230 includes a control unit 233, a compression unit 231, and a second network interface unit (a network card 232 herein). The compression unit 231 is coupled to an image output interface (i.e., the display card 105) of the embedded system 100, for receiving and compressing the output image of the embedded system 100 to generate a compressed image. In this embodiment, the compression unit 231 compresses the output image of the display card 105 according to a Motion Picture Experts Group (MPEG) standard. Afterward, the compressed image (data flow) is sent to the network card 232.

The network card 232 is coupled between the compression unit 231 and the remote apparatus (i.e., the PC 250), for transmitting the compressed image output from the compression unit 231 to the remote apparatus (i.e., the PC 250) via the network 240. After the PC 250 receives the compressed image output from the compression unit 231 via the network 240 and the network card 232, the compressed image is decompressed by a hardware or software technique (i.e., through an application program), so as to restore the compressed image into the output image of the embedded system 100. Through the execution of the application program, the PC 250 can display the output image of the embedded system 100 on the remote display 251. Therefore, even if the embedded system 100 is still in a POST stage, the remote-control servo apparatus 230 can help the remote apparatus (i.e., the PC 250) to monitor the embedded system 100 at the remote side.

The control unit 233 is coupled between the network interface unit (i.e., the network card 232) and the input apparatus interface (i.e., the input controller 106) of the embedded system 100. The control unit 233 receives an input-event (for example, the user operating keyboard 252 and/or mouse 253) of the remote apparatus (i.e., the PC 250) via the network card 232 and the network 240, and generates a corresponding input apparatus signal to the input apparatus interface (i.e., the input controller 106) of the embedded system 100 according to the input-event. In other words, the input-event of the remote apparatus is transmitted to the input controller 106 of the embedded system 100 via the network 240, the network card 232, and the control unit 233, such that the remote apparatus can manage/operate the embedded system 100 via the remote-control servo apparatus 230. Moreover, in this embodiment, the control unit 233 is further coupled to the compression unit 231, for controlling the compression unit 231 and the network card 232 to be initialized. For example, the control unit 233 initializes the network card 232, so as to control the network card 232 to obtain an IP address.

The network 240 is a wired or wireless network. Further, the network 240 may be a private network, LAN, or Internet. The network 210 and the network 240 can be the same network or two different networks.

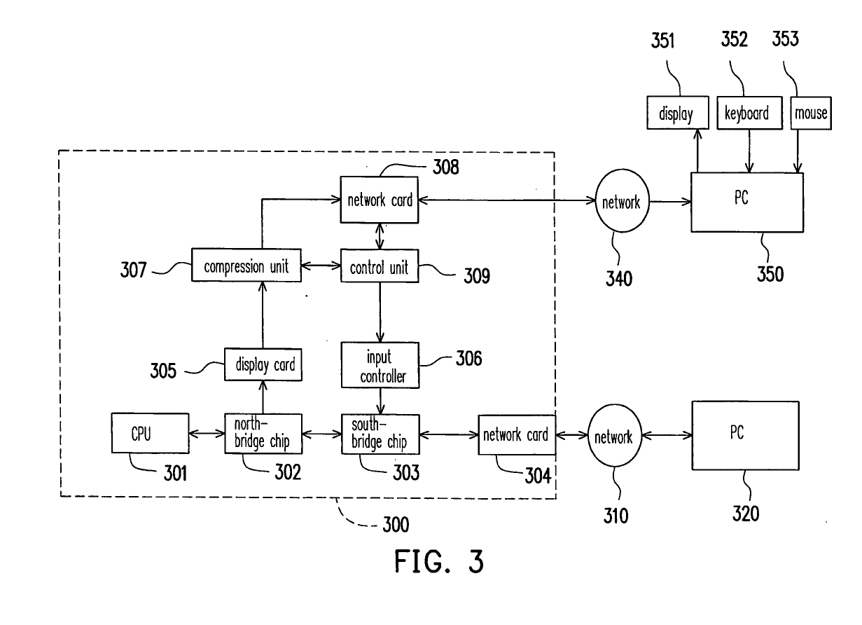

The implementation of the present invention is not limited to the above embodiment, and those of ordinary skill in the art can fulfill the present invention in any methods according to requirements. For example, FIG. 3 is an embedded system according to another embodiment of the present invention. Herein, the embedded system 300 is a server (for example, a home server). The embedded system 300 includes a CPU 301, a chip set (including a north-bridge chip 302 and a south-bridge chip 303 herein), a first network interface unit (a network card 304 herein), a display chip 305, an input apparatus interface (an input controller 306 herein), and a remote-control servo apparatus. The remote-control servo apparatus includes a compression unit 307, a second network interface unit (a network card 308 herein), and a control unit 309.

The display chip 305 is coupled to the north-bridge chip 302, for generating an output image under the control of or driven by the north-bridge chip 302. In this embodiment, the display chip 305 is a VGA display chip or other types of display chip.

The south-bridge chip 303 is coupled between the north-bridge chip 302 and the network card 304, for providing services via the network card 304 under the control of the north-bridge chip 302, and receiving an input interrupt output from the input controller 306. The embedded system 300 provides various services (such as file service) for a network apparatus (for example, a PC 320) via the network card 304 and a network 310 (for example, a LAN). Thereby, the remote PC 320 obtains the service resources provided by the embedded system 300 via the network 310 and the network card 304.

The input controller 306 is coupled to the south-bridge chip 303, for receiving an input apparatus signal, and outputting a corresponding input interrupt to the south-bridge chip 303. Thereby, the CPU 101 can operate correspondingly according to the input interrupt.

The compression unit 307 is coupled to the display chip 305, for receiving and compressing the output image of the display chip 305 to generate a compressed image. In this embodiment, the compression unit 307 is an MPEG compression chip in accordance with the MPEG standard. Afterward, the compressed image (data stream) is sent to the network card 308.

The network card 308 is coupled between the compression unit 307 and a remote apparatus (i.e., a PC 350), for transmitting the compressed image output from the compression unit 307 to the PC 350 via the network 340. After the PC 350 receives the compressed image output from the compression unit 307 via the network 340 and the network card 308, the compressed image is decompressed by a hardware or software technique (i.e., through an application program), so as to restore the compressed image into the output image of the display chip 305. Through the execution of the application program, the PC 350 can display the output image of the embedded system 300 on the remote display 351. Therefore, even if the embedded system 300 is still in a POST stage, the remote apparatus (i.e., the PC 350) can still monitor the embedded system 300 at the remote side.

The control unit 309 is coupled between the network card 308 and the input controller 306. The control unit 309 receives an input-event (for example, a user operating a keyboard 352 and/or a mouse 353) of the remote apparatus (i.e., the PC 350) via the network card 308 and the network 340, and generates a corresponding input apparatus signal to the input controller 306 according to the input-event. The input controller 306 outputs a corresponding input interrupt to the south-bridge chip 303 according to the input apparatus signal. Thereby, the remote apparatus can manage/operate the embedded system 300 via the network 340 and the remote-control servo apparatus. Moreover, in this embodiment, the control unit 309 is further coupled to the compression unit 307, for controlling the compression unit 307 and the network card 308 to be initialized. For example, the control unit 309 initializes the network card 308, so as to control the network card 308 to obtain an IP address.

The networks 340 and 310 are wired or wireless networks. Further, the network 340 may be a private network, LAN, or Internet. The network 310 and the network 340 can be the same network or two different networks.

In view of the above, in the above embodiment, a remote-control servo apparatus is connected to a display card/display chip, so as to transmit a display frame of an embedded system to a display of a remote apparatus via a network, and to transmit an input-event (for example, a user operating a keyboard and/or a mouse) of the remote apparatus to an input controller of the embedded system via the network. Thus, even if the embedded system has not finished the preparation for providing services, and is still in a POST stage, the remote-control servo apparatus can help the remote apparatus to control/operate/monitor the embedded system at the remote side.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A remote-control servo apparatus, comprising:
a compression unit, coupled to an image output interface of an embedded system, for receiving and compressing an output image of the embedded system to generate a compressed image;
a network interface unit, coupled between the compression unit and a remote apparatus, for transmitting the compressed image output from the compression unit to the remote apparatus via a network; and
a control unit, coupled between the network interface unit and an input apparatus interface of the embedded system, for receiving an input-event of the remote apparatus via the network interface unit, and generating a corresponding input apparatus signal to the input apparatus interface of the embedded system according to the input-event, such that the remote apparatus operates the embedded system through the remote-control servo apparatus.

2. The remote-control servo apparatus as claimed in claim 1, wherein the compression unit compresses the output image according to a Motion Picture Experts Group (MPEG) standard.

3. The remote-control servo apparatus as claimed in claim 1, wherein the control unit is further coupled to the compression unit, for controlling the compression unit and the network interface unit to be initialized.

4. The remote-control servo apparatus as claimed in claim 1, wherein the embedded system is a home server.

5. An embedded system, comprising:
a chip set;
a first network interface unit, coupled to the chip set, wherein the embedded system provides services via the first network interface unit;
a display chip, coupled to the chip set, for generating an output image under the control of the chip set;
an input apparatus interface, coupled to the chip set, for receiving an input apparatus signal and outputting a corresponding input interrupt to the chip set; and
a remote-control servo apparatus, comprising:
a compression unit, coupled to the display chip, for receiving and compressing the output image to generate a compressed image;
a second network interface unit, coupled between the compression unit and a remote apparatus, for transmitting the compressed image output from the compression unit to the remote apparatus via a network; and
a control unit, coupled between the second network interface unit and the input apparatus interface, for receiving an input-event of the remote apparatus via the second network interface unit, and generating the corresponding input apparatus signal to the input apparatus interface according to the input-event, such that the remote apparatus operates the embedded system through the remote-control servo apparatus.

6. The embedded system as claimed in claim 5, wherein the input apparatus interface comprises an input controller, for outputting the corresponding input interrupt to the chip set according to the input apparatus signal.

7. The embedded system as claimed in claim 5, wherein the chip set comprises:
a north-bridge chip, coupled to the display chip, for driving the display chip to generate the output image; and
a south-bridge chip, coupled between the north-bridge chip and the first network interface unit, for providing services via the first network interface unit under the control of the north-bridge chip, and receiving the input interrupt output from the input apparatus interface.

8. The embedded system as claimed in claim 5, wherein the compression unit compresses the output image according to an MPEG standard.

9. The embedded system as claimed in claim 5, wherein the control unit is further coupled to the compression unit, for controlling the compression unit and the second network interface unit to be initialized.

10. The embedded system as claimed in claim 5, wherein the embedded system is a home server.
